(19) United States
(12) Patent Application Publication
(10) Pub. No.: US 2026/0343250 A1
(43) Pub. Date: Oct. 29, 2026

(54) CELLULAR TELECOMMUNICATIONS NETWORK

(71) Applicant: British Telecommunications Public Limited Company, London, Greater London (GB)

(72) Inventor: Richard MACKENZIE, London, Greater London (GB)

(21) Appl. No.: 19/110,697

(22) PCT Filed: Aug. 9, 2023
(86) PCT No.: PCT/EP2023/072097

§ 371 Date: Mar. 11, 2025

(30) Foreign Application Priority Data
Sep. 30, 2022 (EP) 22198990.8

(51) Int. Cl. H04W 24/02; H04W 52/02

(52) U.S. Cl. CPC H04W 24/02; H04W 52/0206

(57) ABSTRACT

This invention provides a method in a cellular telecommunications network, and a node for implementing said method, the cellular telecommunications network comprising a plurality of transceivers, the method comprising the steps of: obtaining data including a Physical Cell Identifier, PCI, of each transceiver of the plurality of transceivers; identifying, based on the obtained data, a first PCI conflict between a first pair of transceivers of the plurality of transceivers and a second PCI conflict between a second pair of transceivers of the plurality of transceivers; determining that a solution priority of the first PCI conflict is greater than a solution priority of the second PCI conflict, wherein the solution priorities of the first and second PCI conflicts are based on a respective energy saving status of the respective first and second pairs of transceivers, wherein the energy saving status is one of a normal mode, an energy saving mode and a compensation mode; identifying a solution to the first PCI conflict; and causing a reconfiguration in the cellular telecommunications network to implement the identified solution.

### FIELD OF THE INVENTION

The present invention relates to a cellular telecommunications network.

### BACKGROUND

A Physical Cell Identifier (PCI) is an identifier for a cell of a base station in a cellular telecommunications network. The PCI is broadcast in a physical layer transmission such that any user in the cellular network that receives the physical layer transmission may determine that cell's PCI (even if the user is connected to another cell).

The PCI is allocated to a cell in a cellular network from a finite range (504 in LTE and 1008 in 5G). PCIs must be allocated carefully to avoid a PCI conflict. One form of PCI conflict is known as a PCI collision in which two cells with overlapping coverage areas have the same PCI such that a user in that overlapping coverage area cannot differentiate between the two cells. Another form of PCI conflict is known as a PCI confusion in which a cell has two neighbouring cells with the same PCI. PCI conflicts are known to cause poor user experience, such as increased interference or failed handovers.

Conventionally, PCI assignment is performed manually in order to avoid these PCI conflicts. However, as the density of cellular networks increases due to the increased deployment of small cells (e.g. femtocells), then PCI conflicts may become more common and difficult to manage by manual-allocation of PCIs by the mobile network operator.

The introduction of Self-Organising-Network (SON) capabilities, particular in small cells, enables cells to self-allocate their PCI. This is typically achieved by a cell discovering the PCIs of its neighbouring cells by an Automatic Neighbour Relations (ANR) process—such as by obtaining data from users in measurement reports identifying the neighbouring cells, or by using a Radio Environment Monitoring (REM) scan to detect neighbouring cells—and allocating its PCI based on the PCIs of its neighbouring cells. The SON PCI allocation technique facilitates mass deployment of small cells without increasing the mobile network operator's PCI allocation burden.

A further feature relating to PCI selection is PCI pooling. This is a technique for allocating a PCI to a cell from a particular set of PCIs depending on the cell's class (e.g. macro cell, pico cell, femto cell, etc.). This allows a cell to identify a neighbouring cell's class from its PCI and self-allocate a PCI that avoids a PCI collision with a neighbouring cell of a different class.

The trends of network densification due to the mass deployment of small cells, increasing use of SON-based PCI allocation, and PCI pooling from a limited PCI range means that PCI conflicts are more likely to occur.

### SUMMARY OF THE INVENTION

According to a first aspect of the invention, there is provided a node for a cellular telecommunications network, the cellular telecommunications network comprising a plurality of transceivers, the node comprising: a transceiver configured to obtain data including a Physical Cell Identifier, PCI, of each transceiver of the plurality of transceivers; and a processor configured to: identify, based on the obtained data, a first PCI conflict between a first pair of transceivers of the plurality of transceivers and a second PCI conflict between a second pair of transceivers of the plurality of transceivers, determine that a solution priority of the first PCI conflict is greater than a solution priority of the second PCI conflict, wherein the solution priorities of the first and second PCI conflicts are based on a respective energy saving status of the respective first and second pairs of transceivers, the energy saving status being one of a normal mode, an energy saving mode and a compensation mode, identify a solution to the first PCI conflict, and cause a reconfiguration in the cellular telecommunications network to implement the identified solution.

The energy saving status of the first pair of transceivers may be based on at least one of a group comprising: a current energy saving status of a first transceiver of the first pair of transceivers, a current energy saving status of a second transceiver of the first pair of transceivers, an energy saving status capability of the first transceiver of the first pair of transceivers, and an energy saving status capability of the second first transceiver of the first pair of transceivers.

The energy saving status of the second pair of transceivers may be based on at least one of a group comprising: a current energy saving status of a first transceiver of the second pair of transceivers, a current energy saving status of a second transceiver of second first pair of transceivers, an energy saving status capability of the first transceiver of the second pair of transceivers, and an energy saving status capability of the second first transceiver of the second pair of transceivers.

The solution may be one or more of a group comprising: changing a PCI of one or more of the plurality of transceivers, restricting the energy saving status operating modes of one or more of the plurality of transceivers, wherein the energy saving status operating modes are one of energy saving mode, normal mode and compensation mode, restricting a transmission power of one or more of the plurality of transceivers, and disabling one or more of the plurality of transceivers.

The node may be one of a group comprising: a controller, and a transceiver of the plurality of transceivers.

According to a second aspect of the invention, there is provided a method in a cellular telecommunications network, the cellular telecommunications network comprising a plurality of transceivers, the method comprising the steps of: obtaining data including a Physical Cell Identifier, PCI, of each transceiver of the plurality of transceivers; identifying, based on the obtained data, a first PCI conflict between a first pair of transceivers of the plurality of transceivers and a second PCI conflict between a second pair of transceivers of the plurality of transceivers; determining that a solution priority of the first PCI conflict is greater than a solution priority of the second PCI conflict, wherein the solution priorities of the first and second PCI conflicts are based on a respective energy saving status of the respective first and second pairs of transceivers, wherein the energy saving status is one of a normal mode, an energy saving mode and a compensation mode; identifying a solution to the first PCI conflict; and causing a reconfiguration in the cellular telecommunications network to implement the identified solution.

According to a third aspect of the invention, there is provided a computer program comprising instructions to cause the node of the first aspect of the invention to execute the steps of the method of the second aspect of the invention. The computer program may be stored on a computer readable medium.

### BRIEF DESCRIPTION OF THE FIGURES

In order that the present invention may be better understood, embodiments thereof will now be described, by way of example only, with reference to the accompanying drawings in which:

FIG. 1 is a schematic diagram of a cellular telecommunications network;

FIG. 2 is a schematic diagram of a base station of the network of FIG. 1;

FIG. 3 is a schematic diagram of a controller of the network of FIG. 1;

FIG. 4 is a flow diagram illustrating a first process;

FIG. 5 is a flow diagram illustrating a second process;

FIG. 6 is a flow diagram illustrating a third process;

FIG. 7 is a schematic diagram of a cellular telecommunications network;

FIG. 8 is a flow diagram illustrating a fourth process; and

FIG. 9 is a flow diagram illustrating a fifth process.

### DETAILED DESCRIPTION

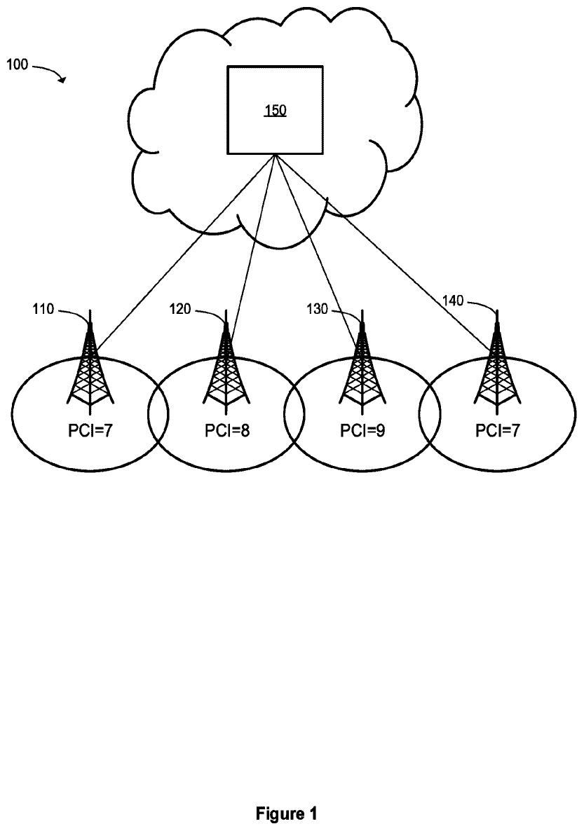

FIG. 1 illustrates a cellular telecommunications network 100. The cellular telecommunications network 100 includes a first base station 110, a second base station 120, a third base station 130 and a fourth base station 140. The first, second, third and fourth base stations 110, 120, 130, 140 each have a single respective transceiver configured to communicate in a respective coverage area (in other words, each base station is a single-cell base station). The first, second, third and fourth base stations 110, 120, 130, 140 communicate using the same frequency.

As shown, the first and second base stations 110, 120 have partially overlapping coverage areas, the second and third base stations 120, 130 have partially overlapping coverage areas, and the third and fourth base stations 130, 140 have partially overlapping coverage areas. The following terminology is noted regarding neighbouring relationships between these base stations. From the perspective of the first base station 110, the second base station 120 is a “first order neighbour” as it has a partially overlapping coverage area with the first base station 110; the third base station 130 is a “second order neighbour” as it is a first order neighbour of a first order neighbour of the first base station 110 (that is, the second base station 120) and it is not itself a first order neighbour of the first base station 110; and the fourth base station 140 is a “third order neighbour” as it is a first order neighbour of a second order neighbour of the first base station 110 (that is, the third base station 130) and it is not itself a first order neighbour or second order neighbour of the first base station 110. For completeness, the following table indicates the neighbouring relationships of the base stations shown in FIG. 1:

| | | Second BS | | Fourth |
|---|---|---|---|---|
| | First BS 110 | 120 | Third BS 130 | BS 140 |
| First BS 110 | N/A | First order | Second Order | Third Order |
| Second BS | First order | N/A | First order | Second order |
| 120 | | | | |
| Third BS 130 | Second order | First order | N/A | First order |
| Fourth BS 140 | Third order | Second order | First order | N/A |

Each of the first, second, third and fourth base stations 110, 120, 130, 140 may be connected to one or more User Equipment (UE) (not shown).

FIG. 1 further illustrates a controller 150. The controller 150 is shown as part of a core network, but in other implementations the controller 150 may be part of the radio access network (e.g. in an Open Radio Access Network, OpenRAN, architecture). The controller 150 is connected (directly or indirectly) to each of the first base station 110, second base station 120, third base station 130 and fourth base station 140.

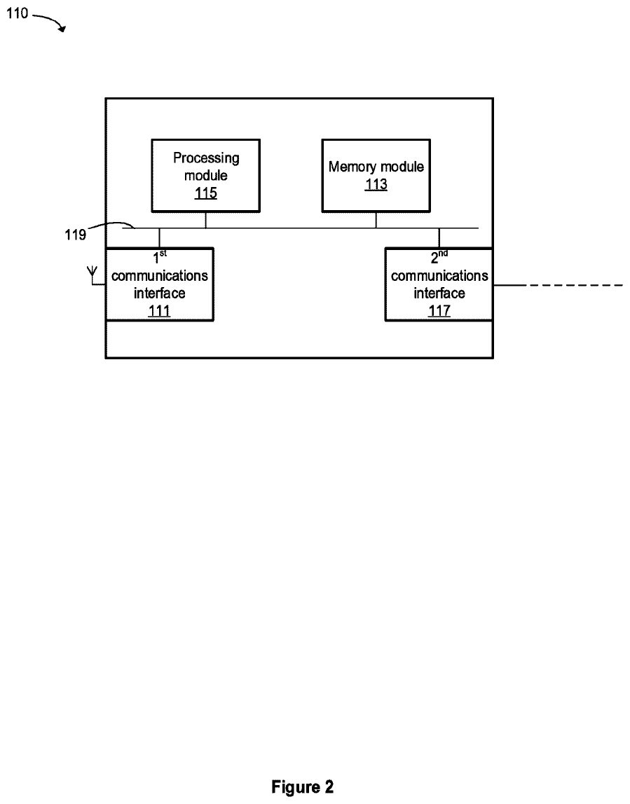

The first base station 110 is shown in more detail in FIG. 2. The first base station 110 includes a first communications interface 111, a memory module 113, a processing module 115 and a second communications interface 117, all connected via communications bus 119. The first communications interface 111 is connected to a transceiver for wireless communications with UE. The second communications interface 117 is a wired (e.g. optical fibre) connection to a core network—including the controller 150—of the cellular telecommunications network 100.

The first base station 110 is identified by (at least) a Physical Cell Identifier (PCI). The PCI is transmitted by the first base station 110 in a physical layer broadcast transmission such that it is decodable by any UE in the cellular telecommunications network 100 (including UE connected to the first base station 110 and UE that are not connected to the first base station 110).

The memory module 113 stores a Neighbour Relations Table (NRT) which identifies one or more other base stations in the cellular telecommunications network 100. The first base station 110 is configured to populate the NRT by:
1. Receiving a measurement report from a UE connected to the first base station 110 identifying another base station in the cellular telecommunications network 100, and adding this other base station to the NRT; and/or
2. Performing a Radio Environment Monitoring (REM) scan (via the first communications interface 111) to detect another base station in the cellular telecommunications network 100, and adding this other base station to the NRT.

These measurement reports and REM scans may identify a PCI that is not already recorded in the NRT. In this case, the PCI is assumed to be transmitted by a neighbouring cell that is not already identified in the NRT. In response, the first base station 110 creates a new record in the NRT for the neighbouring cell and determines its unique identifier (the global cell ID).

The first base station 110 is also configured to communicate its NRT to the controller 150. This may be performed periodically or in response to a trigger (e.g. the NRT being updated).

The second, third and fourth base stations 120, 130, 140 operate in a similar manner so as to transmit their respective PCIs, populate their respective NRTs, and communicate their respective NRTs to the controller 150. As shown in FIG. 1, the first base station 110 uses PCI 7, the second base station 120 uses PCI 8, the third base station 130 uses PCI 9 and the fourth base station 140 uses PCI 7.

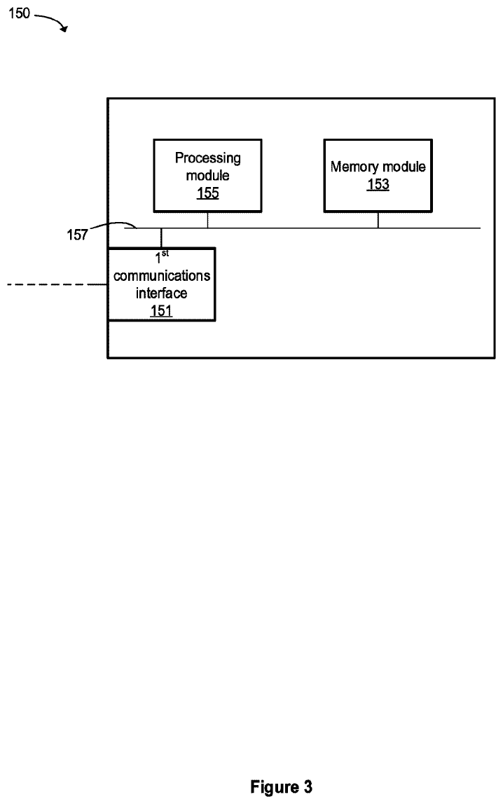

The controller 150 is shown in more detail in FIG. 3. The controller includes a first communications interface 151, a memory module 153 and a processing module 155, all connected via communications bus 157. The first communications interface 151 is a wired (e.g. optical fibre) connection that is (directly or indirectly) connected to each of the first, second, third and fourth base stations 110, 120, 130, 140. The first communications interface 151 may also enable the controller 150 to communicate with other networking nodes, including other controllers in the event the processes (described below) are performed in a distributed environment. The memory module 153 stores a combined NRT which is populated with data from the NRTs received by each of the first, second, third and fourth base stations 110, 120, 130, 140. The combined NRT may therefore identify, for each base station, that base station's first order, second order and third order neighbours. The processing module 155 is configured to perform the first process and/or second process described below.

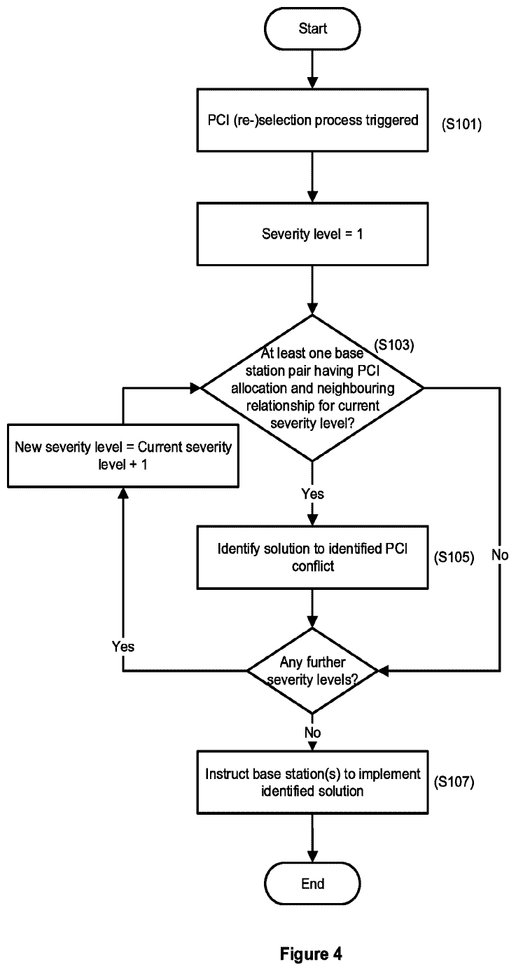

A first process illustrated in the flow diagram of FIG. 4 will now be described. This process is performed by the controller 150 and relates to the cellular network 100 as shown in FIG. 1. In a first step (S101), the controller 150 triggers a PCI (re-)allocation procedure. This trigger may be in response to an event (e.g. the controller 150 receives a message from one or more of the first, second, third and fourth base stations 110, 120, 130, 140 indicating a change in a PCI of any one of the base stations in the network 100 or a change in a neighbouring relationship between the base stations, or a PCI (re-) allocation event triggered within the controller 150 or core network), or the trigger may be time-based (such as expiry of a timer). If there is a change in PCI or in the neighbouring relationship between the base stations, then the combined NRT is updated to incorporate these changes.

In step S103, the controller 150 analyses a current PCI allocation of each base station in the network 100 and the current neighbouring relationships between each pair of base stations in the network 100. This is implemented by entering an iterative loop in which, in each iteration, the current PCI allocation and current neighbouring relationships are analysed to identify one or more base station pairs having a particular combination of PCI allocation and neighbouring relationship. Each iteration is associated with a particular combination of PCI allocation and neighbouring relationship, which are ordered by severity of actual (or potential) degraded network performance for that combination of PCI allocation and neighbouring relationship. These severity levels are listed in the following table:

| Severity | Relationship |
|---|---|
| 1 | First order neighbours with the same PCI value (“PCI collision”) |
| 2 | Second order neighbours with the same PCI value (“PCI |
| | confusion”) |
| 3 | Third order neighbours with the same PCI value |
| 4 | First order neighbours with the same PCI mod3 values |
| 5 | First order neighbours with the same PCI mod4 values |
| 6 | First order neighbours with the same PCI mod30 values |
| 7 | Second order neighbours with the same PCI mod3 values |
| 8 | Second order neighbours with the same PCI mod4 values |
| 9 | Second order neighbours with the same PCI mod30 values |
| 10 | Fourth order neighbours with the same PCI value |
| 11 | Third order neighbours with the same PCI mod3 values |
| 12 | Third order neighbours with the same PCI mod4 values |
| 13 | Third order neighbours with the same PCI mod30 values |
| 14 | Fourth order neighbours with the same PCI mod3 values |
| 15 | Fourth order neighbours with the same PCI mod4 values |
| 16 | Fourth order neighbours with the same PCI mod30 values |

These PCI-relationships include those that are current PCI conflicts (e.g. the relationships of severity levels 1, 2, 4, 5 and 6) that are known to cause degraded network performance, and those that are potential PCI conflicts (e.g. the PCI conflict types of severity levels 3 and 7 to 16) that would realise degraded network performance in the event a higher-order neighbour reconfigures to become a lower-order neighbour. This reconfiguration may occur due to, in a first example, the higher-order neighbour transmitting at a different transmission power so as to change its coverage area to become a lower-order neighbour (such as when a base station compensates for a base station entering energy saving mode) or, in a second example, the higher-order neighbour being a mobile base station that moves to another location so as to change its coverage area to become a lower-order neighbour. These potential PCI conflict types therefore cover scenarios in which two base stations having the same PCI value (or related PCI values) have satisfactory performance with their current respective coverage areas but would have unsatisfactory performance in the event those two base stations reconfigure to become lower-order neighbours.

Applying this step to the cellular network 100 of FIG. 1, in a first iterative loop the controller 150 determines whether a relationship of severity level 1 exists in the network 100. As there are no first order neighbours with the same PCI value, then this determination is negative. The controller 150 therefore enters the second iterative loop and determines whether a relationship of severity level 2 exists in the network 100. There are also no second order neighbours with the same PCI value, so this determination is negative. The controller 150 therefore enters the third iterative loop and determines whether a relationship of severity level 3 exists in the network 100. As the first base station 110 and fourth base station 140 are third order neighbours and have the same PCI value, then this determination is affirmative.

In response to the affirmative determination of step S103, the controller 150 identifies a suitable solution (step S105). As the relationship identified in step S103 is one having a potential PCI conflict, this PCI re-allocation is a pre-emptive solution to the PCI conflict that would occur in the event one or both base stations of the identified base station pair (the first and fourth base stations 110, 140) reconfigure such that the base station pair has a lower-order neighbouring relationship. This pre-emptive solution may be one or more of the following:
Re-allocate one or more PCIs in the cellular network 100; and.
Ensure that one or both of the base stations of the identified pair cannot reconfigure to become lower-order neighbours.

Any pre-emptive solution to re-allocate one or more PCIs in the cellular network 100 may be to re-allocate the PCI of one or both base stations of the identified base station pair and/or one or more other base stations. The reallocated PCIs should not create a relationship having a higher severity level, but may create a relationship having a lower severity level. In the present example, the PCI of the first base station 110 and/or the fourth base station 140 may be changed so that the first and fourth base stations 110, 140 no longer have the same PCI, but not such that one or both of the first and fourth base stations 110, 140 use PCIs 8 or 9 (as that would create a PCI-relationship of severity level 1 or 2). Following this reconfiguration, the one or both base stations of the identified base station pair may reconfigure to become a lower-order neighbour.

Pre-emptive solutions that ensure one or both base stations of the identified base station pair cannot reconfigure to become lower-order neighbours may include one or more of:
One or both of the base stations of the identified base station pair are switched off or instructed to enter energy saving mode;
One or both of the base stations of the identified base station pair have their transmission powers restricted such that they cannot become lower-order neighbours; and
One or both of the base stations of the identified base station pair are prevented from entering compensation mode.

These pre-emptive solutions ensure that one or both base stations cannot reconfigure to become lower-order neighbours (and may involve the base stations continuing to use their current PCIs). These restrictions may also identify acceptable states for each base station in the network depending on other base stations in the network (e.g. one base station may only enter compensation mode if another base station is not in compensation mode) so as to avoid the PCI conflict that would otherwise occur.

Following the identification of a suitable solution in step S105, the controller 150 determines whether there are further relationship severity levels to analyse. As severity levels 4 to 16 have not yet been analysed, then the controller 150 iteratively analyses each severity level and, if a relationship at the severity level exists then a suitable solution is identified that does not create a relationship of a higher severity level. In this example, no further relationships are identified and the controller 150 proceeds to step S107 in which it instructs one or more base stations in the network 100 to implement the identified solution. This may be achieved by sending respective messages to each base station involved in the identified solution which cause each respective base station to implement their part of the identified solution.

The process of FIG. 4 enables the network 100 to pre-emptively solve one or more PCI conflicts that would degrade network performance in the event a neighbouring relationship in the network changes. Conventional PCI allocation procedures typically allocate PCIs to base stations such that there are no PCI conflicts for the current respective coverage area of each base station. However, as cellular networks 100 implement technologies that enable one or more base stations to change their respective coverage area, such as being a mobile base station or a compensation base station for an energy saving base station, then these allocated PCIs may still result in a PCI conflict when the one or more base stations change their respective coverage areas. Although this may be solved by detecting the PCI conflict and re-allocating PCIs in response, the process of FIG. 4 provides a pre-emptive solution such that the potential PCI conflict does not occur when the one or more base stations change their respective coverage areas.

Furthermore, the process of FIG. 4 prioritises solutions for relationships based on the actual or potential performance degradation of each relationship. That is, solutions are ordered by severity level such that solutions are prioritised for relationships that have greater actual or potential performance degradation.

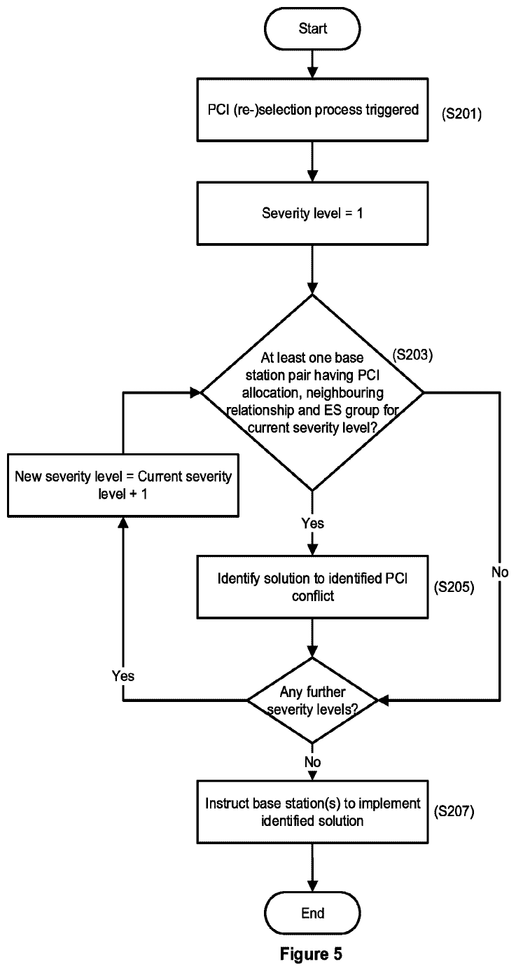

A second process illustrated in FIG. 5 will now be described. This second process is also performed by the controller 150 and also relates to the cellular network 100 shown in FIG. 1. In this second process, the controller 150 additionally stores data relating to the energy saving status of each base station in the network 100. Each base station in the network 100 may operate in either normal mode, energy saving mode (in which it enters an energy saving state) or compensation mode (in which it compensates for another base station entering energy saving mode). Conventionally, base stations are configured to switch between normal mode and energy saving mode, or between normal mode and compensation mode. One or more base stations in the network 100 may be configured to operate in normal mode only. The data stored by the controller 150 identifies, for each base station, its current energy saving status (normal, energy saving, or compensation mode) and its potential energy saving status (normal, energy saving, or compensation mode). This data may be communicated from each base station to the controller 150 (e.g. as part of the NRT update message).

In a first step of this second process (S201), the controller 150 triggers a PCI (re-) allocation procedure. This trigger may be in response to an event or may be time-based.

In step S203, the controller 150 analyses a current PCI allocation of each base station in the network 100, the current neighbouring relationships between each pair of base stations in the network 100, and the energy saving status of each base station in the network 100. This second process introduces a concept of an energy saving priority group. An energy saving priority group relates to the energy saving status of a base station, such as its current energy saving status and its potential energy saving status (that is, the energy saving status of the base station at times of low demand in the network). The energy saving priority group is defined in the following table:

| Energy saving | Potential energy saving | Current energy saving |
|---|---|---|
| priority group | status | status |
| 1 | Compensation mode | Compensation mode |
| 2 | Compensation mode | Normal mode |
| 3 | Normal mode | Normal mode |
| 4 | Energy saving mode | Normal mode |
| 5 | Energy saving mode | Energy saving mode |

In the example shown in FIG. 1, the first and fourth base stations 110, 140 are in energy saving priority group 2 (they are currently in normal mode but may operate in compensation mode at times of low network demand) and the second and third base stations 120, 130 are in energy saving priority group 4 (they are currently in normal mode but may operate in energy saving mode at times of low network demand).

In the following analysis, the concept of the “maximum energy saving priority group” is also defined to indicate the maximum energy saving priority group of a base station pair identified as having a particular combination of PCI allocation and neighbouring relationship. In the example shown in FIG. 1 in which the first and fourth base stations 110, 140 are third order neighbours having the same PCI, the maximum energy saving priority group for this base station pair is 2.

Turning back to FIG. 5, in step S203, the controller 150 enters an iterative loop in which, in each iteration, the controller 150 analyses the current PCI allocation and current neighbouring relationships to identify one or more base station pairs having a particular combination of PCI allocation and neighbouring relationship and, further, determines whether the maximum energy saving priority group of any identified base station pair equals a particular value. These iterations are again ordered by severity of actual (or potential) degraded network performance for that combination of PCI allocation, neighbouring relationship and maximum energy saving priority group. These severity levels are listed in the following table:

| | Max ES | |
|---|---|---|
| | priority | |
| Severity | group | Relationship |
| 1 | 1 | First order neighbours with the same PCI value (“PCI |
| | | collision”) |
| 2 | 2 | First order neighbours with the same PCI value (“PCI |
| | | collision”) |
| 3 | 1 | Second order neighbours with the same PCI value |
| | | (“PCI confusion”) |
| 4 | 2 | Second order neighbours with the same PCI value |
| | | (“PCI confusion”) |
| 5 | 3 | First order neighbours with the same PCI value (“PCI |
| | | collision”) |
| 6 | 2 | Third order neighbours with the same PCI value |
| 7 | 3 | Third order neighbours with the same PCI value |
| 8 | 1 | First order neighbours with the same PCI mod3 values |
| 9 | 2 | First order neighbours with the same PCI mod3 values |
| 10 | 1 | First order neighbours with the same PCI mod4 values |
| 11 | 2 | First order neighbours with the same PCI mod4 values |
| 12 | 3 | First order neighbours with the same PCI mod3 values |
| 13 | 1 | Second order neighbours with the same PCI mod3 |
| | | values |
| 14 | 2 | Second order neighbours with the same PCI mod3 |
| | | values |
| 15 | 3 | First order neighbours with the same PCI mod4 values |
| 16 | 1 | Second order neighbours with the same PCI mod4 |
| | | values |
| 17 | 2 | Second order neighbours with the same PCI mod4 |
| | | values |
| . . . | . . . | . . . |

Further severity levels and corresponding relationships are not shown for the sake of brevity (and may additionally encompass a severity level for each maximum energy saving priority group with each combination of PCI relationship and neighbouring relationship in the table for the first process, or a subset thereof).

Applying the process of FIG. 5 to the network shown in FIG. 1, the controller 150 does not identify any base station pairs having the combination of PCI allocation, neighbouring relationship and maximum energy saving priority group of severity levels 1 to 5, but does identify a base station pair having the combination of PCI allocation, neighbouring relationship and maximum energy saving priority group of severity level 6 (that is, the first and fourth base stations 110, 140 are third order neighbours having the same PCI value and the maximum energy saving priority group of the first and fourth base stations 110, 140 is 2).

The process then proceeds to step S205 in which a suitable solution is identified to pre-emptively solve this potential PCI-conflict. The controller 150 may identify a solution that involves one or more of re-allocating one or more PCIs in the cellular network 100 and ensuring that one or both of the base stations of the identified base station pair cannot reconfigure to become lower-order neighbours. The solution may be based on the energy saving statuses of the base stations such that any performance degradation as a result of the solution is primarily suffered by the base station of the identified base station pair having the relatively low energy saving priority group (for example, if a first base station of an identified base station pair has energy saving priority group 1 and a second base station of that identified base station pair has energy saving priority group 2, then the solution would primarily sacrifice performance of the second base station, such as by restricting the transmission power of the second base station or reallocating PCIs in the network such that a PCI conflict of the second base station is more severe than any PCI conflict of the first base station). In other words, any performance changes as a result of the solution ensure that performance of the base station of the identified base station pair having the relatively high energy saving priority group are favoured over performance of the base station of the identified base station pair having the relatively low energy saving priority group.

In step S207, the controller 105 instructs one or more base stations in the network 100 to implement the identified solution.

By considering the current and potential energy saving statuses of the base stations involved in the identified relationship, the second process may therefore prioritise solutions that favour performance of base stations that contribute more to overall network performance. That is, a base station that is currently in compensation mode or is configured to compensate for other base stations that enter energy saving mode contributes more to overall network performance (in terms of the number of users served and throughput, for example) than a base station that is in energy saving mode or is configured to enter energy saving mode. Therefore, any solution to pre-emptively solve a potential PCI-conflict that involves degraded performance of one of the base stations involved in the potential PCI-conflict should prioritise performance of the base station more likely to compensate for one or more other base stations.

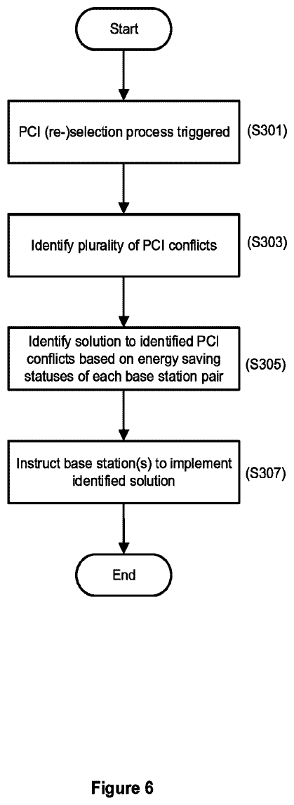

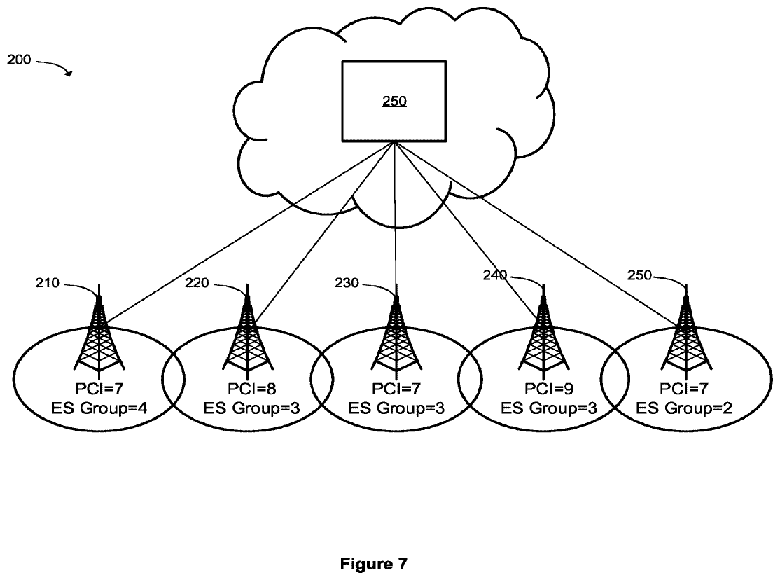

A third process illustrated in FIG. 6 will now be described with reference to the network 200 shown in FIG. 7. FIG. 7 illustrates a network 200 having a controller 250, a first base station 210, second base station 220, third base station 230, fourth base station 240 and fifth base station 250. As shown, the first and second base stations 210, 220 have partially overlapping coverage areas, the second and third base stations 220, 230 have partially overlapping coverage areas, the third and fourth base stations 230, 240 have partially overlapping coverage areas, and the fourth and fifth base stations 240, 250 have partially overlapping coverage areas. The third process may be performed by the controller 250.

In this third process, the controller 250 stores data on the PCI allocation and energy saving status of each base station in the network 200. The energy saving status data stored by the controller 250 identifies, for each base station, its current energy saving status (normal, energy saving, or compensation mode) and its potential energy saving status (normal, energy saving, or compensation mode). This data may be communicated from each base station to the controller 250. The controller 250 may identify an energy saving priority group for each base station in the network 200. As noted above, the energy saving priority group relates to the energy saving status of a base station, such as its current energy saving status and its potential energy saving status. The energy saving priority group is defined in the following table:

| Energy saving | Potential energy saving | Current energy saving |
|---|---|---|
| priority group | status | status |
| 1 | Compensation mode | Compensation mode |
| 2 | Compensation mode | Normal mode |
| 3 | Normal mode | Normal mode |
| 4 | Energy saving mode | Normal mode |
| 5 | Energy saving mode | Energy saving mode |

In the network of FIG. 7, the first base station 210 uses PCI 7 and is in energy saving priority group 4, the second base station 220 uses PCI 8 and is in energy saving priority group 3, the third base station 230 uses PCI 7 and is in energy saving priority group 3, the fourth base station 240 uses PCI 9 and is in energy saving priority group 3, and the fifth base station 250 uses PCI 7 and is in energy saving priority group 2.

In a first step of the third process (S301), the controller 250 triggers a PCI (re-)allocation procedure. This trigger may be in response to an event (such as a change in PCI or energy saving status of a base station in the network 200) or may be time-based.

In step S303, the controller 250 analyses the current PCI allocations in the network to identify a plurality of PCI conflicts. Applying this step to the network shown in FIG. 7, the controller 150 identifies a first PCI conflict between the first base station 210 and the third base station 230 (second order neighbours having the same PCI), and further identifies a second PCI conflict between the third base station 230 and the fifth base station 250 (again, second order neighbours having the same PCI). It is noted that the PCI conflict between the first and fifth base stations 210, 250 is ignored as, in this example, the controller 250 only identifies PCI conflicts between first, second and third order neighbours.

In step S305, the controller 250 identifies a solution for the plurality of PCI conflicts identified in step S303. This solution is based on the maximum (that is, highest priority) energy saving priority group of the respective base station pair of each PCI conflict. In FIG. 7, the maximum energy saving priority group of the base station pair of the first PCI conflict is 3, and the maximum energy saving priority group of the base station pair of the second PCI conflict is 2). The solution is such that any network performance degradation as a result of the solution is more likely for the base station pair having a relatively high maximum priority energy saving priority group value and therefore more likely to enter energy saving mode. In other words, the solution ensures that performance of the base station pair having the relatively low maximum energy saving priority group (that is, the base station pair more likely to compensate for other base stations) is favoured over performance of the base station pair having the relatively high maximum energy saving priority group (that is, the base station pair more likely to enter energy saving mode). In this example in which the plurality of PCI conflicts includes a first PCI conflict—in which the maximum energy saving priority group of the base stations involved in the first PCI conflict is 3—and also includes a second PCI conflict—in which the maximum energy saving priority group of the base stations involved in the second PCI conflict is 2—then the controller identifies a solution which prioritises performance of the second PCI conflict over the first PCI conflict. In other words, the identified solution is one in which any network performance degradation is suffered (at least primarily) by the base stations involved in the first PCI conflict.

The identified solution may involve reallocating PCIs to the base stations in the network 200. In this scenario, the reallocated PCIs should solve the second PCI conflict and any network performance degradation from the reallocation should be suffered by the base stations involved in the first PCI conflict. For example, the PCI allocation may involve a reallocation of the PCI for the third base station 230 such that the third and fifth base stations 230, 250 no longer have the same PCI, even if the change results in the first and third base stations 210, 230 having another form of PCI conflict.

In step S307, the controller 250 instructs each base station to implement their respective parts of the identified solution.

Similar to the second process detailed above, this third process also considers the current and potential energy saving statuses of the base stations involved in the identified PCI conflicts so as to prioritise solutions that favour performance of base stations that contribute more to overall network performance. That is, a base station that is currently in compensation mode or is configured to compensate for other base stations that enter energy saving mode contributes more to overall network performance (in terms of the number of users served and throughput, for example) than a base station that is in energy saving mode or is configured to enter energy saving mode. Therefore, the solution to a PCI-conflict that involves degraded performance of one of the base stations involved in the PCI-conflict should prioritise performance of the base station that is configured to compensate for one or more other base stations over performance of the base station that is configured to enter energy saving mode.

As described above, the controller 150 of FIG. 1 is configured to perform the first and second process and the controller 250 of FIG. 7 is configured to perform the third process. However, this is non-essential and the first, second and third processes may be performed by one or more of the base stations. That is, the base stations may exchange the necessary data (such as NRT data and energy saving status data) in inter-base station messaging such that the remaining steps of each process may be performed locally. The base stations may identify the neighbouring relationships between base stations by comparison of NRT data. For example, if a first base station receives an NRT from a first neighbouring base station that is detectable by the first base station (such that the first neighbouring base station is a first order neighbour of the first base station) and that NRT includes data on a second neighbouring base station that is not detectable by the first base station, then that second neighbouring base station is a second order neighbour. The NRT may include the neighbour order for each base station (from the perspective of the base station populating the NRT) to reduce computation.

In the second and third processes detailed above, the energy saving priority group was used to define multiple energy saving statuses of a base station (including its current energy saving status and potential energy saving status). Each base station may multiple potential energy saving statuses, in which case the energy saving priority group should reflect the energy saving status having the greatest coverage. Furthermore, a single energy saving status (current or potential) could be used instead.

Instead of identifying the maximum energy saving priority group of a base station involved in a PCI conflict, a minimum energy saving priority group could be used. A combined energy saving priority group could also be used that represents the respective energy saving priority group of each base station involved in the PCI conflict. This combination may be achieved by averaging or adding the respective energy saving priority groups.

In the processes described above, one of the solutions to a PCI conflict is to configure the coverage area of the base stations involved such that the PCI conflict cannot occur (such as by restricting the transmission power of one or more base stations). The skilled person will understand that these solutions may not remove the PCI conflict but merely reduce the performance degradation caused by that PCI conflict below a threshold amount. For example, the solution may be to reduce the transmission power of one of the base stations involved in the conflict such that the conflict still exists but within a smaller geographical area.

The processes above are described in the context of a conventional radio access network. However, the processes may also be applied to a disaggregated radio access network having a remote unit and a centralised unit (such as a disaggregated unit and/or a central unit). In this scenario, upon discovering a PCI conflict between two remote units, a check may be carried to determine if they have a common centralised unit. The threshold amount of performance degradation that may be accepted may be relatively higher if the two remote units have a common centralised unit.

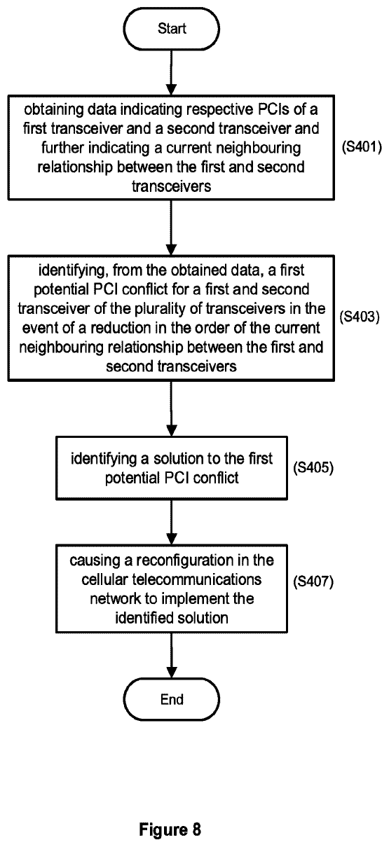

FIG. 8 illustrates a fourth process implementable in a node of the network of FIG. 1. In step S401 the node obtains data indicating respective Physical Cell Identifiers, PCIs, of a first transceiver and a second transceiver of the plurality of transceivers and further indicating a current neighbouring relationship between the first and second transceivers, the current neighbouring relationship between the first and second transceivers being of a particular order. In step S403 the node identifies, from the obtained data, a first potential PCI conflict for a first and second transceiver of the plurality of transceivers in the event of a reduction in the order of the current neighbouring relationship between the first and second transceivers. In step S405 the node identifies a solution to the first potential PCI conflict. In step S407 the node causes a reconfiguration in the cellular telecommunications network to implement the identified solution.

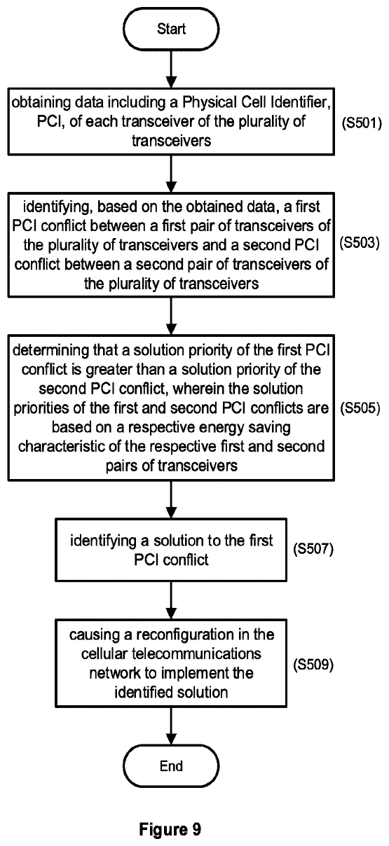

FIG. 9 illustrates a fifth process implementable in a node of the network of FIG. 7. In step S501 the node obtains data including a Physical Cell Identifier, PCI, of each transceiver of the plurality of transceivers. In step S503 the node identifies, based on the obtained data, a first PCI conflict between a first pair of transceivers of the plurality of transceivers and a second PCI conflict between a second pair of transceivers of the plurality of transceivers. In step S505, the node determines that a solution priority of the first PCI conflict is greater than a solution priority of the second PCI conflict, wherein the solution priorities of the first and second PCI conflicts are based on a respective energy saving characteristic of the respective first and second pairs of transceivers. In step S507, the node identifies a solution to the first PCI conflict. In step S509, the node causes a reconfiguration in the cellular telecommunications network to implement the identified solution.

The skilled person will understand that any combination of features is possible within the scope of the invention, as claimed.

1. A node for a cellular telecommunications network, the cellular telecommunications network comprising a plurality of transceivers, the node comprising:
a transceiver configured to obtain data including a Physical Cell Identifier, (PCI) of each transceiver of the plurality of transceivers; and
a processor configured to:
identify, based on the obtained data, a first PCI conflict between a first pair of transceivers of the plurality of transceivers and a second PCI conflict between a second pair of transceivers of the plurality of transceivers,
determine that a solution priority of the first PCI conflict is greater than a solution priority of the second PCI conflict, wherein the solution priorities of the first and second PCI conflicts are based on a respective energy saving status of the respective first and second pairs of transceivers, the energy saving status being one of a normal mode, an energy saving mode and a compensation mode,
identify a solution to the first PCI conflict, and
cause a reconfiguration in the cellular telecommunications network to implement the identified solution.

2. A The node as claimed in claim 1, wherein the energy saving status of the first pair of transceivers is based on at least one of:
a current energy saving status of a first transceiver of the first pair of transceivers,
a current energy saving status of a second transceiver of the first pair of transceivers,
an energy saving status capability of the first transceiver of the first pair of transceivers, or
an energy saving status capability of the second transceiver of the first pair of transceivers.

3. The node as claimed in claim 1, wherein the energy saving status of the second pair of transceivers is based on at least one of:
a current energy saving status of a first transceiver of the second pair of transceivers,
a current energy saving status of a second transceiver of the second pair of transceivers,
an energy saving status capability of the first transceiver of the second pair of transceivers, or
an energy saving status capability of the second transceiver of the second pair of transceivers.

4. The node as claimed in claim 1, wherein the solution is one or more of a group comprising:
changing a PCI of one or more of the plurality of transceivers,
restricting the energy saving status operating modes of one or more of the plurality of transceivers,
restricting a transmission power of one or more of the plurality of transceivers, or
disabling one or more of the plurality of transceivers.

5. The node as claimed in claim 1, being a controller or a transceiver of the plurality of transceivers.

6. A method in a cellular telecommunications network, the cellular telecommunications network comprising a plurality of transceivers, the method comprising the steps of:
obtaining data including a Physical Cell Identifier (PCI) of each transceiver of the plurality of transceivers;
identifying, based on the obtained data, a first PCI conflict between a first pair of transceivers of the plurality of transceivers and a second PCI conflict between a second pair of transceivers of the plurality of transceivers;
determining that a solution priority of the first PCI conflict is greater than a solution priority of the second PCI conflict, wherein the solution priorities of the first and second PCI conflicts are based on a respective energy saving status of the respective first and second pairs of transceivers, wherein the energy saving status is one of a normal mode, an energy saving mode and a compensation mode;
identifying a solution to the first PCI conflict; and
causing a reconfiguration in the cellular telecommunications network to implement the identified solution.

7. (canceled)

8. A non-transitory computer readable medium having stored thereon instructions which when executed by a computer perform the method of claim 6.

9. The method as in claim 6, wherein the energy saving status of the first pair of transceivers is based on:
a current energy saving status of a first transceiver of the first pair of transceivers,
a current energy saving status of a second transceiver of the first pair of transceivers,
an energy saving status capability of the first transceiver of the first pair of transceivers, and/or
an energy saving status capability of the second transceiver of the first pair of transceivers.

10. The method as in claim 6, wherein the energy saving status of the second pair of transceivers is based on:
a current energy saving status of a first transceiver of the second pair of transceivers,
a current energy saving status of a second transceiver of the second pair of transceivers,
an energy saving status capability of the first transceiver of the second pair of transceivers, and/or
an energy saving status capability of the second transceiver of the second pair of transceivers.

11. The method as in claim 6, wherein the solution includes:
changing a PCI of one or more of the plurality of transceivers,
restricting the energy saving status operating modes of one or more of the plurality of transceivers,
restricting a transmission power of one or more of the plurality of transceivers, and/or
disabling one or more of the plurality of transceivers.
